(19) United States
(12) Patent Application Publication
(10) Pub. No.: US 2020/0097163 A1
(43) Pub. Date: Mar. 26, 2020

(54) MOBILE APPLICATION FOR SMART SYSTEMS INTERACTION

(71) Applicant: Carrier Corporation, Palm Beach Gardens, FL (US)

(72) Inventors: Francesco Leonardi, Palm Beach Gardens, FL (US); Muthuswamy Hariharamuthu, Palm Beach Gardens, FL (US); Dang Nguyen, Palm Beach Gardens, FL (US); Nagavendra Chappa, Palm Beach Gardens, FL (US); Bhabani Sankar Nanda, Palm Beach Gardens, FL (US)

(21) Appl. No.: 16/553,708

(22) Filed: Aug. 28, 2019

Related U.S. Application Data
(60) Provisional application No. 62/735,986, filed on Sep. 25, 2018.

(51) Int. Cl. G06F 3/0484; G06F 3/0482; G05B 13/04; H04L 12/28; H04W 4/33; H04N 21/41

(52) U.S. Cl. CPC G06F 3/04847; G06F 3/0482; H04N 21/4126; H04L 12/2807; H04W 4/33; G05B 13/041

(57) ABSTRACT

A building control system includes a building server interconnected with multiple building systems. The building systems include a heating ventilation and cooling (HVAC) system, a lighting system, and an access/reservation system. A mobile application is configured to be installed on at least one mobile device, and is configured to cause the at least one mobile device to interface with the building server and to display a graphical user interface (GUI). The GUI includes a location pane configured to display a location of the mobile device within a building, a comfort pane configured to display an increase option and a decrease option, a lighting pane configured to display a lighting option of the location of the mobile device and to display a lighting control option, and an access pane configured to display access information of at least one entryway of the building.

### CROSS-REFERENCE TO RELATED APPLICATION

This application claims priority to U.S. Provisional Patent Application No. 62/735986 filed Sep. 25, 2018.

### TECHNICAL FIELD

The present disclosure relates generally to control applications for building systems, and more specifically to a unified graphical user interface for a mobile application that interacts with multiple building systems.

### BACKGROUND

Current buildings include many smart building systems including heating, ventilation and cooling (HVAC) systems, lighting systems, automated door locks, and the like. Each of the smart building systems can include their own proprietary interfaces and operations, and can include their own corresponding control applications. In some examples, the building systems can be interacted with using standard mobile devices and systems, and in other cases the building systems include dedicated apps, or complicated control devices, in order to implement the controls.

Occupants and regular visitors to buildings including multiple distinct building systems are faced with multiple scattered ways to interact with the building systems, each of which can have its own subsystems, interfaces, and features. Further complicating the interfacing is the fact that smart building systems typically carry with them increased levels and amounts of control over the corresponding system. The increased amount of control, and the varied means by which that control is achieved, can make it difficult for a regular user to fully understand and manipulate the corresponding controls. This difficulty is exacerbated for infrequent users and/or guests who may not be familiar with a given control scheme.

### SUMMARY OF THE INVENTION

In one exemplary embodiment a building control system includes a building server interconnected with a plurality of building systems, wherein the building systems include a heating ventilation and cooling (HVAC) system, a lighting system, and an access/reservation system, a mobile application configured to be installed on at least one mobile device, and configured to cause the at least one mobile device to interface with the building server and to display a graphical user interface (GUI), wherein the GUI includes a location pane configured to display a location of the mobile device within a building, a comfort pane configured to display an increase option and a decrease option, a lighting pane configured to display a lighting option of the location of the mobile device and to display a lighting control option, and an access pane configured to display access information of at least one entryway of the building.

In another example of the above described building control system the lighting option is a dimmer slider ranging from 0% (off) to 100% brightness.

In another example of any of the above described building control systems the GUI further includes a maps pane configured to display at least one map of the building.

In another example of any of the above described building control systems the access pane includes a first option configured to open a list of available conference rooms, and allow a user to reserve an available conference from the list of available conference rooms.

In another example of any of the above described building control systems the access pane includes a second option configured cause the mobile application to interface with the access system and unlock at least one entryway of the at least one entryway of the building.

In another example of any of the above described building control systems the access system is further interfaced with the location pane and wherein the at least one entryway of the at least one entryway of the building that is unlocked is an entryway corresponding to the location of the mobile device within the building.

In another example of any of the above described building control systems at least one of the building server and the mobile application include a memory storing at least one preferred entryway, and wherein the mobile application defaults to providing access to the preferred entryway in response to multiple entryways being at the location of the mobile device.

In another example of any of the above described building control systems the mobile application further includes a user credentialing system configured to interface with the building server, and determine an access level credential of a user of the mobile device.

In another example of any of the above described building control systems the GUI includes a login screen, and wherein the user is required to gain access level credentials from the building server through the mobile device prior to the GUI displaying the location pane, the comfort pane, the lighting pane and the access pane.

In another example of any of the above described building control systems the user is required to provide biometric verification to gain access level credentials.

In another example of any of the above described building control systems the location pane includes a dropdown menu configured to allow a user to manually override a detected location of the mobile device.

In another example of any of the above described building control systems the comfort pane is configured to display at least a current temperature of the location of the mobile device within the building.

In one exemplary embodiment a mobile application for controlling smart building systems includes a graphical user interface including, a location pane configured to display a location of the mobile device within a building, a comfort pane configured to display at least a current temperature of the location of the mobile device within the building and to display an increase option and a decrease option, a lighting pane configured to display a lighting option of the location of the mobile device and to display a lighting control option, and an access pane configured to display access information of at least one entryway of the building.

In another example of the above described mobile application for controlling smart building systems the increase option and the decrease option each consists of a single corresponding button.

In another example of the above described mobile application for controlling smart building systems the lighting control option consists of a slider bar having a minimum lighting on a first end and a maximum lighting on a second end.

In another example of the above described mobile application for controlling smart building systems the location of the mobile device within the building is a contextually determined location and the location is determined via at least one of data from the mobile device, data from a building server.

Another example of the above described mobile application for controlling smart building systems further includes a single search option configured to receive one of a conference room name, a point of interest name, a point of interest type, and a user name and cause the mobile application to perform a corresponding search.

In another example of the above described mobile application for controlling smart building systems the graphical user interface is configured to display a location of a user within a building in response to receiving the user name.

In another example of the above described mobile application for controlling smart building systems the graphical user interface is configured to display a reservation system for reserving a conference room in response to receiving the conference room name.

In another example of the above described mobile application for controlling smart building systems the graphical user interface is configured to sort results of the search by a distance from a mobile device operating the mobile application.

These and other features of the present invention can be best understood from the following specification and drawings, the following of which is a brief description.

### BRIEF DESCRIPTION OF THE DRAWINGS

FIG. 1 illustrates an exemplary building including multiple smart building systems.

FIG. 2 schematically illustrates a control system for providing user control of the smart building systems.

FIG. 3 schematically illustrates an exemplary user login screen of a mobile application for controlling the smart building systems.

FIG. 4-5 schematically illustrate a main screen of the mobile application.

FIG. 6 schematically illustrates a maps screen of the mobile application.

### DETAILED DESCRIPTION OF AN EMBODIMENT

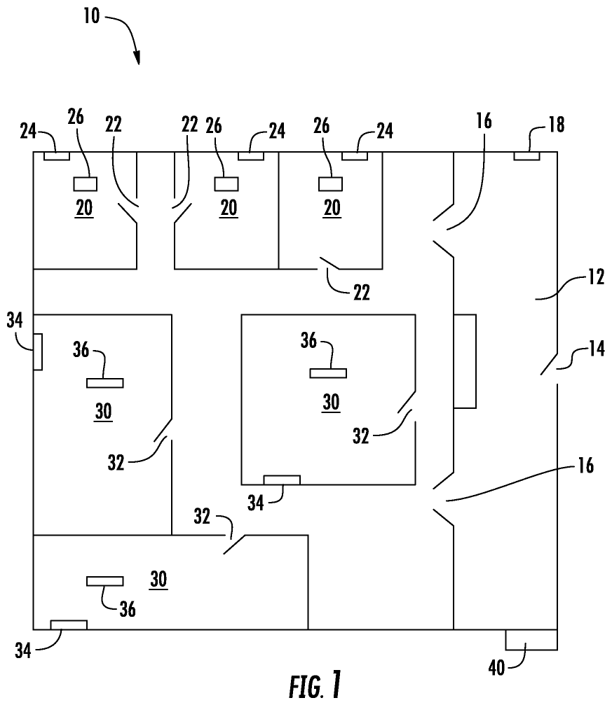

FIG. 1 schematically illustrates an exemplary floorplan of a sample floor 10 for a building including multiple smart building systems. The floor 10 includes a reception area 12 having an entryway 14 connecting to an outside of the building and two entryways 16 connecting to a remainder of the floor 10. Three offices 20 are included, each with their own corresponding entryway 22. Additionally included are three conference rooms 30, each with a corresponding entryway 32. Each of the offices 20, conference rooms 30, and reception area 12 includes a corresponding dedicated smart heating, ventilation and cooling (HVAC) system 18, 24, 34. Each of the Offices 20 and conference rooms 30 include smart lighting systems 26, 36. While the exemplary floor 10 includes three smart building systems (lighting, HVAC, and entryways) it is appreciated that a practical building could expand this to any number of additional smart systems and the three illustrated smart systems are purely exemplary in nature.

Also connected to the floor 10 is a building systems server 40. The server 40 is configured to connect with each smart building system within the floor 10, and to connect with a control application installed on one or more mobile device. The connections can be direct physical connections, such as wiring within the walls, data connections through a wireless network, data connections through the internet, or any combination of similar connections. While illustrated as a single building systems server 40 controlling a single floor 10, it is appreciated that multiple servers 40 can operate in conjunction and/or multiple floors 10 can be controlled via the described system.

In existing buildings, each of the smart building systems includes its own control scheme and/or mobile control application. As described above, this can result to confusion or difficulty in operation of the building control systems due to different control schemes, overly complex levels of control, and the utilization of multiple different control applications. To alleviate this difficulty, the smart building systems of FIG. 1 interconnect with the building server 40 via the application programing interface (API) of each smart building system. The building server 40 can then connect with a custom control application installed on one or more corresponding mobile devices. The custom control application allows an authorized user in possession of the mobile device to control relevant building systems in a simple and intuitive manner.

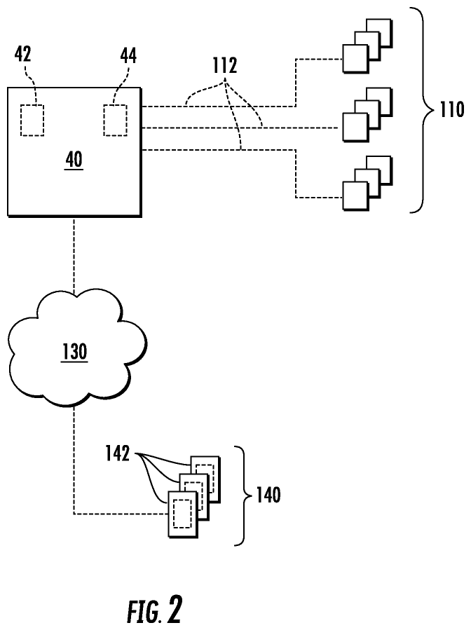

With continued reference to the FIG. 1, FIG. 2 schematically illustrates an exemplary data connection allowing operation of the custom control application. The building server 40 is connected to each of the smart building systems 110 via a corresponding data connection 112. The building server 40 utilizes the built in API of each smart building system to provide control commands readable by the corresponding smart building system over the data connection 112. The data connections 112 can be wireless, wired, or a combination and can be achieved using any conventional data communication protocol. Also connected to the building system 40, via the internet 130, are multiple mobile devices 140. Each of the mobile devices 142 includes the custom control application 142 installed on the device.

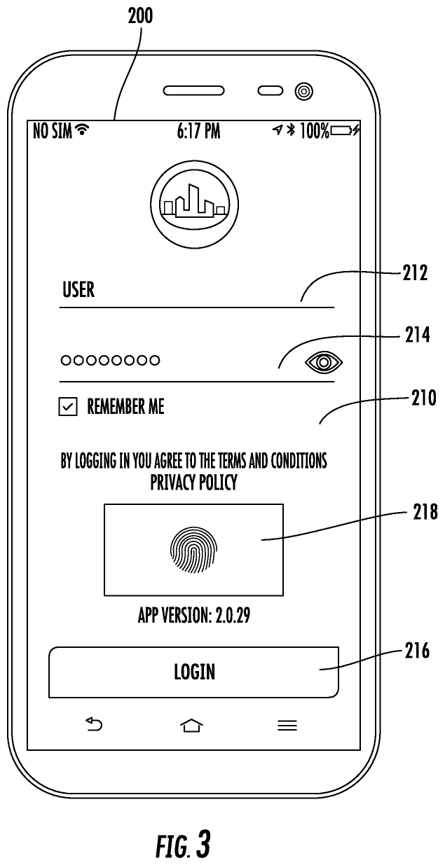

The custom control application 142 utilizes a graphical user interface (GUI) (illustrated in FIGS. 3-6) to present the user with simple control operations. When a control operation is received by the mobile device 140 through the GUI, the mobile device 140 provides the control operation to the building server 40 through the internet 130. In alternative systems, where more security or control is required, the connection between the mobile devices 140 and the building server 40 can be restricted to connections over a local wireless communication protocol, can require an authorized login before operation, or both.

Once received at the building server 40, the control commands are converted by the building server 40 into a corresponding API instruction, or set of API instructions for the relevant building systems 110, and the API instruction is provided to the relevant building systems 110 over the data connections 112.

In some examples, the building server 40 can include an authorization system 42. The authorization system 42 can receive a username and password, or other login credentials such as a biometric authorization, and determine an appropriate access level for the user. Once the appropriate access level has been determined, the access level is provided to the corresponding mobile device 140. By way of example, if a user has access to one office 20, and one conference room 30, then the user's mobile device 140 will be limited to controlling the building systems within the office 20 and conference room 30, as well as the entryways limiting access to the office 20 and conference room 30.

In yet further examples, the building server 40 can include a user location detection system 44. The user location detection system 44 can detect a position of a given user within the floor 10 based on context such as nearby smart building systems, which wireless data point the user is connected to, global positions systems, or any similar attribute. The location detection system 44 can then provide the location of the user to the corresponding mobile device 140, and enable additional control functions within the custom control application 142.

With continued reference to FIGS. 1 and 2, FIG. 3 schematically illustrates a login screen 210 of a graphical user interface 200 of the custom control application 142 according to a first example. The login screen 210 includes a username field 212 and a password field 214, each of which allows the user to enter the corresponding information. Once entered, the user can submit the username and password via a login button 216. In examples including a biometric login, the login screen 210 also includes a biometric authorization pane 218. When the user interacts with the biometric authorization pane 218, any biometric authorization technique supported by the mobile device can be performed and the biometric authorization can be provided to the building server 40. In the example of FIG. 3, the biometric authorization is a fingerprint authorization.

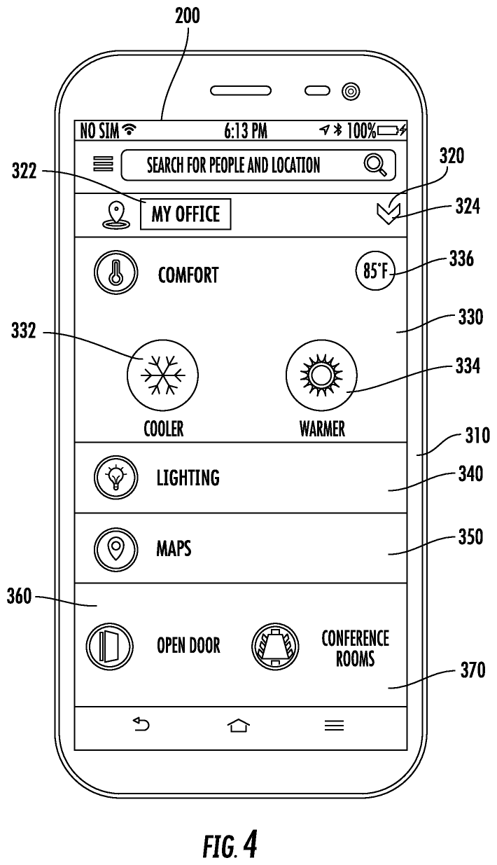

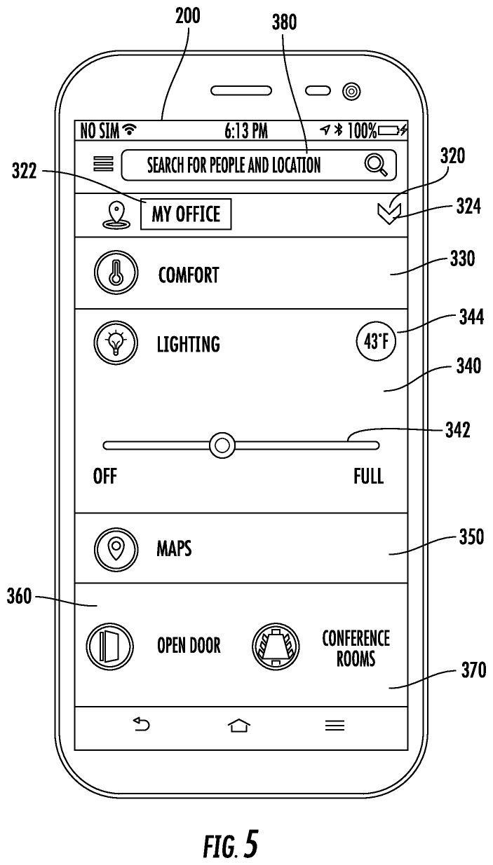

Once the authorization is submitted, and a corresponding authorization level has been determined by the authorization system 42 and transmitted back to the mobile device 140, the GUI 200 transitions to a home screen 310. With continued reference to FIG. 3, FIGS. 4 and 5 illustrate an exemplary home screen 310 in a first state (FIG. 4) and a second state (FIG. 5).

The home screen 310 includes a location pane 320. The location pane 320 displays the current location of the mobile device 140 operating the custom control application 142 via a text display 322. In some example applications, the location pane 320 can further include a drop down menu 324. The drop down menu 324 allows the user to manually override the detected location displayed in the text display 322 when the detected location is incorrect. By way of example, where two locations are in close proximity (such as adjoining offices 20), the user can activate the drop down menu and select the correct location. Once selected, the override lasts until the mobile device 140 detects that the user has moved to a new location within the floor 10 at which time the mobile device 140 will update the displayed location with the newest detected location.

In some examples, the user of a given mobile device 140 can set a preference for a specific location within the mobile device 140. The preference is used as a tie breaker by the custom control application 142 when two potential locations within the building are simultaneously detected with approximately the same likelihood. In such an example, the custom control application 142 will inform the building server 40 of the preference and the location will be determined to be the preferred location. In alternative examples, the preference can be stored within the building server 40 and associated with the user's authorization.

Also included within the home screen 310 is a comfort pane 330. When the user selects the comfort pane 330, the pane 330 is expanded (as shown in FIG. 4), and when a different pane is selected, the comfort pane 330 is contracted (as shown in FIG. 5). While expanded, the comfort pane 330 provides the user with a cooler button 332 and a warmer button 334. In the illustrated example, an actual temperature of the detected location can be displayed in a temperature display 336 within the comfort pane 330. In alternative examples the control can be further simplified by omitting the temperature display 336 entirely.

When the user interacts with the cooler button 332, the custom control application 142 provides an instruction to the building server 40 that the user wishes their current location to be cooler. The building server 40 then converts the cooler instruction into appropriate control signals for the HVAC system 18, 24, 34 of the current location and reduces the temperature. Conversely, when the user interacts with the warmer button 334, the same process occurs with an increase in temperature instead of a decrease.

By utilizing only the cooler button 332 and the warmer button 334, in conjunction with the detected location, the environmental controls of a given room are greatly simplified.

In some examples, such as those where multiple distinct users are in the same room (e.g. a conference room 30), the building server 40 can utilize a vote tallying system where a receipt of multiple different votes between cooler and warmer are received. In such an event, the building server 40 can take action according to the most votes selected. In alternative examples, the building server 40 can register the amount of distinct votes for cooler and warmer, and provide the information to building technicians. Provisions of the vote tally to the building technicians allows the technicians to adjust the HVAC systems for future operations, and the building server 40 will maintain the HVAC system 28, 24, 34 in its current state.

The example home screen 310 of FIG. 5 illustrates the comfort pane 330 contracted, and a lighting pane 340 expanded. The lighting pane 340 includes a slider bar 342 that the user can slide from a 0% (off) position to a 100% (full brightness) position. In the illustrated example, the lighting pane includes a current brightness display 344 which displays the numerical percentage of the brightness in the current location. In alternative examples, the brightness display 344 can be omitted. When the user adjusts the slider to be brighter or dimmer, a corresponding instruction is sent from the custom control application 142 to the building server 40. The building server 40 then converts the dimmer instruction to control signals for the lighting systems 26, 36 of the corresponding office 20 or conference room 30.

By correlating the brighter/dimmer instruction with the users current location, the building server 40 can adjust the brightness of only the lighting systems 26, 36 of the current room without requiring the user to navigate through a complex lighting control system and identify the specific lights they wish to dim or brighten.

The home screen 310 also includes maps pane 350. Interaction with the maps pane 350 causes each other pane to collapse, and opens a map of the current location, as identified in the location pane 320. The map can, in some examples be expandable, allowing a user to identify the relative position within the building of the current location, and identify relevant points of interest such as restrooms, faucets, emergency exits, and the like that may be in close proximity to the current location.

In yet other examples, the maps pane 350 can allow the user to search for a specific location, or allow the user to identify a location in which the user is scheduled to attend a meeting. Once the location is identified, the custom control application can generate a map indicating the route the user should take in order to find the identified location.

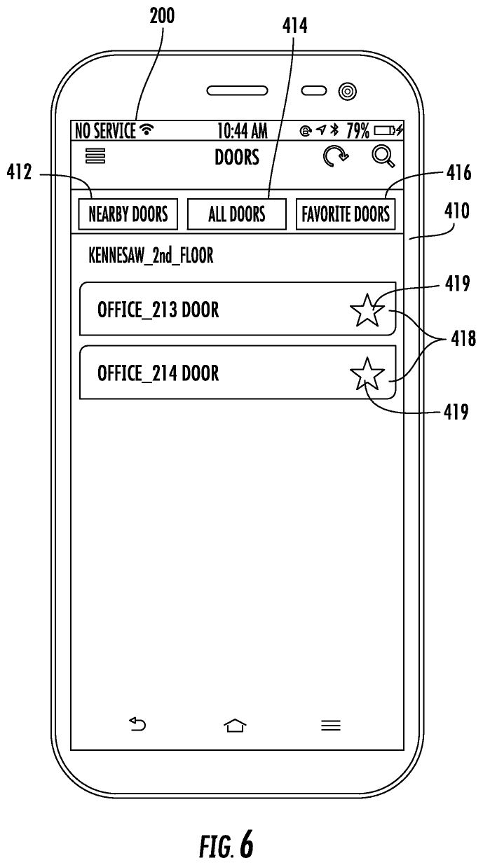

Also included on the home screen 310 is an open door button 360. When selected, the open door button 360 switches the custom control application 142 from the home screen 310 to a door selection screen 410. The door selection screen 410 is illustrated in FIG. 6. The exemplary door selection screen 410 includes three options, nearby doors 412, all doors 414, and favorite doors 416. Selection of any of the three options 412, 414, 416 presents a list of entry ways 416, 22, 32 that fall within the selected option 412, 414, 416.

Each of the listed entry ways is presented via a labeled button 418. When the user clicks on the labeled button 418 corresponding to the door that the user wishes to pass through, the custom control application 142 submits a request to the building server 40. If the user is authorized to access that room, the building server 40 interacts with the building access systems and instructs the door in the corresponding entryway 26, 22, 32 to unlock and/or open. In addition, each of the buttons includes a favorite icon 419 that the user can interact with in order to designate a door as a favorite door or de-designate a door as a favorite door. When designated as a favorite, the door identifier is stored at the mobile device 140 or at the server 40 as a favorite, and can be used in tie breaker scenarios when one or more door is equally close.

Referring again to the home screen 310, illustrated in FIGS. 4 and 5, a conference room button 370 is also included on the home screen 310. As with the open door button 360, selection of the conference room button 370 brings the user to an available conference rooms screen. From the available conference room screen the user can select an unused conference room and reserve it for a conference. The room selected can be based on proximity to the user, size, or any number of other factors.

In addition to the previously listed panes 320, 330, 340, 350 and buttons 360, 370, the home screen 310 includes a search field 380. The search field 380 allows the user to search for rooms, points of interest (e.g. specific building locations), point of interest types (e.g. restrooms), or other users. Optionally, the results of any search can be sorted by distance from the mobile device running the application. When the user enters a room name or number into the search field 380, the maps pane 350 will expand, and a map providing directions to, and details of, the searched for room will be loaded. In the event that the search string results in more than one room, a selection menu is presented to the user prior to opening the maps pane 350.

When another user's name is entered into the search field 380, the custom control application 142 communicates with the building server 40 and determines if the user operating the custom control application is authorized to locate the searched for user. If the operator is authorized, then the building server 40 identifies a location within the building of the searched for user and displays that location to the operator of the custom control application 142. In the event that the user is not in the building, a message informing the operator that the user is not in the building can be presented instead.

In some examples, the location of the searched for user can be identified in conjunction with additional information known to the building server 40, such as how long the searched for user has been in their present location, how to get to the present location of the searched for user and the like.

In yet further examples, searching for a user can provide the operator of the custom control application with a prompt to alert the searched for user. Selecting the prompt will provide an alert to the mobile device of the searched for user, indicating that the operator of the custom control application 142 has requested their attention.

While illustrated in FIGS. 3-6 as a particular layout, one of skill in the art will appreciate that the graphical user interface of the custom control application can include additional panes corresponding to additional smart building systems that may be installed in the building, as well as a different relative position of the graphical elements, without impacting the functionality described herein.

It is further understood that any of the above described concepts can be used alone or in combination with any or all of the other above described concepts. Although an embodiment of this invention has been disclosed, a worker of ordinary skill in this art would recognize that certain modifications would come within the scope of this invention. For that reason, the following claims should be studied to determine the true scope and content of this invention.

1. A building control system comprising:
a building server interconnected with a plurality of building systems, wherein the building systems include a heating ventilation and cooling (HVAC) system, a lighting system, and an access/reservation system;
a mobile application configured to be installed on at least one mobile device, and configured to cause the at least one mobile device to interface with the building server and to display a graphical user interface (GUI), wherein the GUI includes a location pane configured to display a location of the mobile device within a building, a comfort pane configured to display an increase option and a decrease option, a lighting pane configured to display a lighting option of the location of the mobile device and to display a lighting control option, and an access pane configured to display access information of at least one entryway of the building.

2. The building control system of claim 1, wherein the lighting option is a dimmer slider ranging from 0% (off) to 100% brightness.

3. The building control system of claim 1, wherein the GUI further includes a maps pane configured to display at least one map of the building.

4. The building control system of claim 1, wherein the access pane includes a first option configured to open a list of available conference rooms, and allow a user to reserve an available conference from the list of available conference rooms.

5. The building control system of claim 1, wherein the access pane includes a second option configured cause the mobile application to interface with the access system and unlock at least one entryway of the at least one entryway of the building.

6. The building control system of claim 5, wherein the access system is further interfaced with the location pane and wherein the at least one entryway of the at least one entryway of the building that is unlocked is an entryway corresponding to the location of the mobile device within the building.

7. The building control system of claim 5, wherein at least one of the building server and the mobile application include a memory storing at least one preferred entryway, and wherein the mobile application defaults to providing access to the preferred entryway in response to multiple entryways being at the location of the mobile device.

8. The building control system of claim 1, wherein the mobile application further includes a user credentialing system configured to interface with the building server, and determine an access level credential of a user of the mobile device.

9. The building system of claim 8, wherein the GUI includes a login screen, and wherein the user is required to gain access level credentials from the building server through the mobile device prior to the GUI displaying the location pane, the comfort pane, the lighting pane and the access pane.

10. The building system of claim 9, wherein the user is required to provide biometric verification to gain access level credentials.

11. The building control system of claim 1, wherein the location pane includes a dropdown menu configured to allow a user to manually override a detected location of the mobile device.

12. The building system of claim 1, wherein the comfort pane is configured to display at least a current temperature of the location of the mobile device within the building.

13. A mobile application for controlling smart building systems comprising:
a graphical user interface including;
a location pane configured to display a location of the mobile device within a building;
a comfort pane configured to display at least a current temperature of the location of the mobile device within the building and to display an increase option and a decrease option;
a lighting pane configured to display a lighting option of the location of the mobile device and to display a lighting control option; and
an access pane configured to display access information of at least one entryway of the building.

14. The mobile application of claim 13, wherein the increase option and the decrease option each consists of a single corresponding button.

15. The mobile application of claim 13, wherein the lighting control option consists of a slider bar having a minimum lighting on a first end and a maximum lighting on a second end.

16. The mobile application of claim 13, wherein the location of the mobile device within the building is a contextually determined location and the location is determined via at least one of data from the mobile device, data from a building server.

17. The mobile application of claim 13, further comprising a single search option configured to receive one of a conference room name, a point of interest name, a point of interest type, and a user name and cause the mobile application to perform a corresponding search.

18. The mobile application of claim 17, wherein the graphical user interface is configured to display a location of a user within a building in response to receiving the user name.

19. The mobile application of claim 17, wherein the graphical user interface is configured to display a reservation system for reserving a conference room in response to receiving the conference room name.

20. The mobile application of claim 17 wherein the graphical user interface is configured to sort results of the search by a distance from a mobile device operating the mobile application.
